(19) United States
(12) Patent Application Publication
(10) Pub. No.: US 2025/0324959 A1
(43) Pub. Date: Oct. 23, 2025

(54) Fishing Data Calculation Method, Mobile Terminal, and Fishing Reel System

(71) Applicant: Shenzhen Bosaidong Technology Co., Ltd., Shenzhen (CN)

(72) Inventors: Huangshen Qu, Shenzhen (CN); Tianshi Cui, Shenzhen (CN)

(21) Appl. No.: 18/973,153

(22) Filed: Dec. 9, 2024

(30) Foreign Application Priority Data
Apr. 19, 2024 (CN) 202410482053.5

(51) Int. Cl. A01K 91/20

(52) U.S. Cl. CPC A01K 91/20

(57) ABSTRACT

Disclosed are a fishing data calculation method, a mobile terminal, and a fishing reel system. The method includes: pre-constructing a winding database of different fishing lines wound to a spool of a fishing reel; acquiring a current winding length of a current fishing line on the spool; acquiring a current number of circles of unwinding of the spool during casting; and calculating a current unwinding length corresponding to the current number of circles of unwinding according to the winding database and the current winding length. In the disclosure, the winding database of the different fishing lines wound to the spool of the fishing reel is pre-constructed, and the unwinding length of the fishing line on the spool is calculated by an algorithm based on the fishing line selected by a user when the user performs fishing, thereby having the advantage of improving the calculation accuracy of the unwinding length.

### CROSS REFERENCES TO RELATED APPLICATION

The present application claims the benefit of Chinese Patent Application No. 202410482053.5 filed on Apr. 19, 2024, the contents of which are incorporated herein by reference in their entirety.

### TECHNICAL FIELD

The present disclosure relates to the technical field of fishing data processing, and more particularly relates to a fishing data calculation method, a mobile terminal, and a fishing reel system.

### BACKGROUND ART

With the rise of outdoor sport fishing, more and more people participate in sport fishing. During the process of fishing, it is difficult for an angler to measure a casting distance after casting, especially during fishing in the sea, it is more difficult to master the casting distance without a reference object on the sea surface, and the angler who fails to well master the casting distance is likely to have ineffective casting and waiting.

In order to solve the above problem, a digital display fishing reel with the function of calculating an unwinding length is currently launched on the market. When a fishing line is wound to a spool of the digital display fishing reel by the angler, a length capacity is obtained based on the thickness of the spool and the number of circles of winding; however, since different fishing lines on the market may have different wire attributes, different length capacities may be obtained by winding the fishing lines of different wire attributes on the same spool, which results in errors in the calculation of fishing data during casting.

### SUMMARY OF THE INVENTION

It is an object of the present disclosure to provide a fishing data calculation method, a mobile terminal, and a fishing reel system, which aim to solve the problem that the calculation of an unwinding distance of an existing fishing reel is not accurate enough during casting.

In a first aspect, an example of the present disclosure provides a fishing data calculation method, including:
pre-constructing a winding database of different fishing lines wound to a spool of a fishing reel;
acquiring a current winding length of a current fishing line on the spool;
acquiring a current number of circles of unwinding of the spool during casting; and
calculating a current unwinding length corresponding to the current number of circles of unwinding according to the winding database and the current winding length.

In a second aspect, an example of the present disclosure provides a mobile terminal, including a memory and a processor, wherein a computer program is stored in the memory, and the processor, when executing the computer program, implements the above fishing data calculation method.

In a third aspect, an example of the present disclosure provides a fishing reel system, including a fishing reel and the above mobile terminal;
the fishing reel including:
a fishing reel main body;
a spool rotatably mounted on the fishing reel main body;
a swing arm rotatably mounted on the fishing reel main body and connected to the spool; and
a sensor assembly disposed between the fishing reel main body and the spool and configured to detect rotation data of the spool.

The present disclosure has the following beneficial effects: by pre-constructing the winding database of the different fishing lines wound to the spool of the fishing reel, the unwinding length of the spool is calculated by an algorithm based on the fishing line selected by a user when the user performs fishing, thereby having the advantage of improving the calculation accuracy of the unwinding length.

### BRIEF DESCRIPTION OF THE DRAWINGS

In order to more clearly illustrate the technical solutions of the examples of the present disclosure, a brief description will be given to the accompanying drawings which need to be used in the description of the examples below. Apparently, the drawings in the description below are some examples of the present disclosure, and other drawings may also be obtained from these drawings by a person ordinarily skilled in the art without involving any inventive effort.

FIG. 1 is a schematic flow diagram of a fishing data calculation method provided in an example of the present disclosure;

FIG. 2 is a schematic subflow diagram of the fishing data calculation method provided in an example of the present disclosure;

FIG. 3 is another schematic subflow diagram of the fishing data calculation method provided in an example of the present disclosure; and

FIG. 4 is a schematic block diagram of a mobile terminal provided in an example of the present disclosure.

### DETAILED DESCRIPTION OF THE INVENTION

The technical solutions in the examples of the present disclosure will be described clearly and completely in conjunction with the accompanying drawings in the examples of the present disclosure below. Apparently, the examples described are some examples, but not all examples of the present disclosure. Based on the example in the present disclosure, all other examples obtained by a person ordinarily skilled in the art without involving any inventive effort should fall within the scope of protection of the present disclosure.

It should be understood that the terms “including” and “containing”, when used in this specification and the appended claims, indicate the presence of the described features, entireties, steps, operations, elements and/or modules, but do not preclude the presence or addition of one or more other features, entireties, steps, operations, elements, modules and/or aggregations thereof.

It should also be understood that the terms used in the specification of the present disclosure herein are for the purpose of describing particular examples only and are not intended to limit the present disclosure. As used in the specification and the appended claims of the present disclosure, the singular forms “a”, “an”, and “the” are intended to include the plural forms as well, unless the context clearly indicates otherwise.

It should be further understood that the term “and/or” used in the specification and the appended claims of the present disclosure refers to any combination and all possible combinations of one or more of the associated listed items, and includes these combinations.

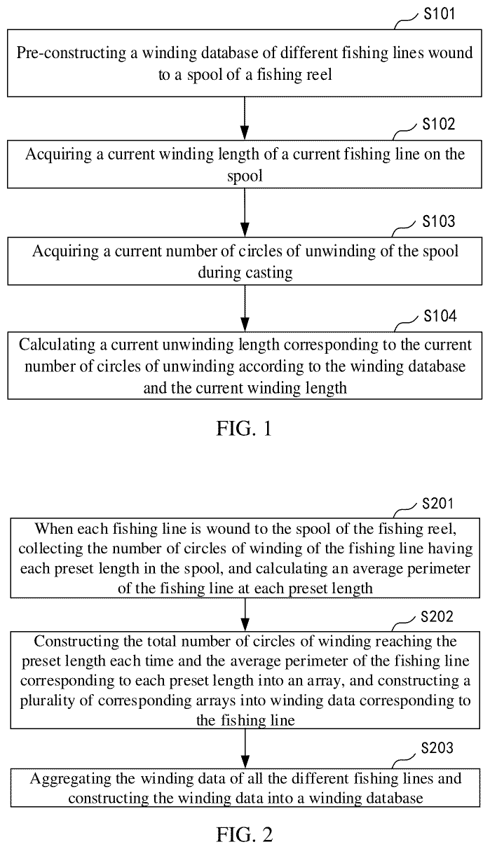

Referring to FIG. 1, FIG. 1 is a schematic flow diagram of a fishing data calculation method provided in an example of the present disclosure.

As shown in FIG. 1, the method includes steps S101 to S104.
S101. pre-constructing a winding database of different fishing lines wound to a spool of a fishing reel.

In this step, when fishing lines of different wire attributes are wound and filled on the spool by the spool as a winding container, filling densities of the fishing lines of different wire attributes are different, the wire attributes include a line diameter magnitude, the greater the line diameter of the fishing line is, the greater the winding density on the spool is, namely, in the case of the same number of circles, the greater the line diameter of the fishing line is, the shorter the length of the fishing line wound on the spool is, or in the case of the same length, the greater the line diameter of the fishing line is, the less the number of circles of the fishing line wound on the spool is; the less the line diameter of the fishing line is, the less the winding density on the spool is, namely, in the case of the same number of circles, the less the line diameter of the fishing line is, the longer the length of the fishing line wound on the spool is, or in the case of the same length, the less the line diameter of the fishing line is, the greater the number of circles of the fishing line wound on the spool is; and therefore, corresponding winding data may be constructed for each fishing line of different line diameters, and the winding data of a plurality of fishing lines is aggregated and constructed into the winding database. The winding data refers to information about the number of circles, perimeter information and length information of different fishing lines wound to the spool of the fishing reel. The information about the number of circles, the perimeter information and the length information refer to the number of circles, the perimeter and the length of the fishing lines wound on the spool, respectively.

In this step, in order to improve the accuracy of the winding data of different fishing lines, the wire attributes may also include a wire type, when the fishing lines with the same line diameters but different wire types are wound and filled on the spool, the filling densities are also different, for example, when using the wire types with different ductility, for example, using nylon lines, PE lines, and carbon lines, the better the ductility of the fishing line is, the greater the length of the fishing line wound on the spool is, and the poorer the ductility of the fishing line is, the less the length of the fishing line wound on the spool is; and therefore, by adding the wire types of the fishing lines, the accuracy of the winding data of different fishing lines may be improved.

In this step, in order to further improve the accuracy of the winding data of different fishing lines, the wire attributes may further include one or more of a wire size and a wire tensile force, and it should be understood that when the fishing lines with different wire sizes and different wire tensile forces are wound and filled on the spool, the filling density may also be affected, the larger the wire size of the fishing line is, the less the number of circles of the fishing line wound on the spool is, and the greater the wire tensile force of the fishing line is, the greater the number of circles of the fishing line wound on the spool is.

Based on this, in this step, different wire attributes of different fishing lines may be set based on actual requirements, namely, the wire attributes include one or more of the line diameter magnitude, the wire type, the wire size, and the wire tensile force, thereby improving the accuracy of the winding database.
S102. acquiring a current winding length of a current fishing line on the spool.

In this step, the current winding length may be acquired when the current fishing line is wound to the spool. In one acquiring mode, the current fishing line with a pre-made length may be wound to the spool, namely, the pre-made length is the current winding length. In another acquiring mode, when the current fishing line is wound to the spool, a current number of circles of winding of the current fishing line is collected by a sensor assembly disposed on the fishing reel, based on the information about the wire attributes of the current fishing line selected by a user, winding data corresponding to the current fishing line may be matched in the winding database, and by taking the matched winding data as a standard, the current winding length of the current fishing line on the spool may be accurately calculated.
S103. acquiring a current number of circles of unwinding of the spool during casting.

In this step, a number of circles of rotation of the spool during casting may be identified by the sensor assembly, and the number of circles of rotation obtained by identification is the current number of circles of unwinding of the spool.
S104. calculating a current unwinding length corresponding to the current number of circles of unwinding according to the winding database and the current winding length.

In this step, on the basis of the winding data corresponding to the current fishing line and the current winding length, a current number of remaining circles may be calculated through the current number of circles of unwinding and the current number of circles of winding, and then a current remaining length is calculated based on the current number of remaining circles; and finally, the accurate current unwinding length may be obtained based on the current winding length and the current remaining length.

In this example, in steps S101 to S104, how to accurately calculate the current unwinding length during casting is introduced, so that an angler can well master a casting distance, thereby greatly avoiding ineffective casting and waiting, and effectively improving the use experience.

In a specific implementation mode of this example, the user performs communication connection (such as Bluetooth connection) and binding with the fishing reel through a mobile terminal in advance; before the current fishing line is wound to the spool, the mobile terminal responds to one or more of the wire attributes of the current fishing line, namely, the line diameter magnitude, the wire type, the wire size, and the wire tensile force, input by the user; when the current fishing line is wound to the spool, rotation data of the spool is detected by the sensor assembly to acquire the current number of circles of winding of the current fishing line; and based on the pre-constructed winding database, high-precision calculation of a winding capacity may be achieved, so that the current winding length (namely, a current maximum distance which may be cast) corresponding to the current number of circles of winding is obtained.

In an example, as shown in FIG. 2, step S101 includes:
S201. when each fishing line is wound to the spool of the fishing reel, collecting the number of circles of winding of the fishing line having each preset length in the spool, and calculating an average perimeter of the fishing line at each preset length;
S202. constructing the total number of circles of winding reaching the preset length each time and the average perimeter of the fishing line corresponding to each preset length into an array, and constructing a plurality of corresponding arrays into winding data corresponding to the fishing line; and
S203. aggregating the winding data of all the different fishing lines and constructing the winding data into a winding database.

In this example, when each fishing line is wound to the spool of the fishing reel, the number of circles of winding of the fishing line having each preset length on the spool is collected, and the average perimeter of the fishing line at each preset length is calculated according to this; and then the total number of circles of winding reaching the preset length each time and the average perimeter of the fishing line corresponding to each preset length are constructed into an array, wherein parameters in the array include: {the total number of circles of winding, the average perimeter}, //n*the preset length, n is the number of arrays (namely, the number of times the preset length is reached). A collecting mode may be as follows: by starting from 0 circle, the fishing line is wound on the spool, the total number of circles of winding and the number of circles of winding within a range of each preset length are recorded once every time the preset length is reached, and the average perimeter within the range of each preset length, namely, the average perimeter of each circle of fishing line within a range of a corresponding number of circles, may be obtained by dividing the preset length by the number of circles of winding within the range of each preset length. For example, by starting from 0 circle, the fishing line is wound on the spool, when the preset length L_{A1} is reached for the first time, the total number of circles of winding is recorded as Q_{A1} for the first time, and a value is calculated by dividing L_{A1} by Q_{A1}, so as to obtain the average perimeter C_{A1} of the fishing line within the range of the first preset length L_{A1} (namely, the average perimeter within the range of the number of circles Q_{A1}); the fishing line continues to be wound after reaching the preset length L_{A1} for the first time, and when the preset length L_{A1} is reached for the second time, the total number of circles of winding is recorded as Q_{A2} for the second time, and a value is calculated by dividing L_{A1} by (Q_{A2}−Q_{A1}), so as to obtain the average perimeter C_{A2} of the fishing line within the range of the second preset length L_{A1} (namely, the average perimeter within the range of the number of circles Q_{A1} to Q_{A2}); and the fishing line continues to be wound after reaching the preset length L_{A1} for the second time, and when the preset length L_{A1} is reached for the third time, the total number of circles of winding is recorded as Q_{A3} for the third time, and a value is calculated by dividing L_{A1} by (Q_{A3}−Q_{A2}), so as to obtain the average perimeter C_{A3} of the fishing line within the range of the third preset length L_{A1} (namely, the average perimeter within the range of the number of circles Q_{A2} to Q_{A3}). Subsequently, recording of the parameters of the array is performed in the same manner. For convenience of understanding, specific instances are introduced below.

By taking the fishing line A with the line diameter of 0.1 mm and a PE wire as an example, by starting from 0 circle, the fishing line is wound on the spool, and the winding data of the fishing line A is as follows:

$$\begin{matrix}\{ {Q}_{A 1} , {C}_{A 1} \} , // {L}_{A 1} array 1 ; \\ \{ {Q}_{A 2} , {C}_{A 2} \} , // 2 {L}_{A 1} array 2 ; \\ \{ {Q}_{A 3} , {C}_{A 3} \} , // 3 {L}_{A 1} array 3 ; \\ \{ {Q}_{A 4} , {C}_{A 4} \} , // 4 {L}_{A 1} array 4 … ;\end{matrix}$$

wherein Q represents the total number of circles of winding; C represents the average perimeter of each circle of fishing line within the range of the corresponding number of circles (namely, at the corresponding preset length); L represents the preset length, in the unit of m; and Q_{A1}<Q_{A2}<Q_{A3}<Q_{A4}, and C_{A1}<C_{A2}<C_{A3}<C_{A4}.

Wherein Q_{A1} represents that a total of Q_{A1} circles of the fishing line are wound by starting from 0 circle, C_{A1} represents the average perimeter of each circle (namely, at the first preset length) of the fishing line within the range of Q_{A1} circles, and L_{A1} represents the length of the fishing line used for being wound for a total of Q_{A1} circles by starting from 0 circle.

Q_{A2} represents that a total of Q_{A2} circles of the fishing line are wound by starting from 0 circle, C_{A2} represents the average perimeter of each circle of the fishing line within the range of Q_{A1} to Q_{A2} circles (namely, at the second preset length), and 2L_{A1} represents the length of the fishing line used for being wound for a total of Q_{A2} circles by starting from 0 circle. Namely, on the basis of the Q_{A1} circles, the length of the fishing line used for being wound for (Q_{A2}−Q_{A1}) circles again is also L_{A1}, in other words, it is understood that on the basis of the Q_{A1} circles, the fishing line with the length L_{A1} is wound again, and the number of circles used for winding the fishing line with this length again is (Q_{A2}−Q_{A1}).

Q_{A3} represents that a total of Q_{A3} circles of the fishing line are wound by starting from 0 circle, C_{A3} represents the average perimeter of each circle of the fishing line within the range of Q_{A2} to Q_{A3} circles (namely, at the third preset length), and 3L_{A1} represents the length of the fishing line used for being wound for a total of Q_{A3} circles by starting from 0 circle. Namely, on the basis of the Q_{A2} circles, the length of the fishing line used for being wound for (Q_{A3}−Q_{A2}) circles again is also L_{A1}, in other words, it is understood that on the basis of the Q_{A2} circles, the fishing line with the length L_{A1} is wound again, and the number of circles used for winding the fishing line with this length again is (Q_{A3}−Q_{A2}).

It is performed in the same manner below.

By taking the fishing line B with the line diameter of 0.2 mm and a carbon wire as an example, the winding data of the fishing line B is as follows:

$$\begin{matrix}\{ {Q}_{B 1} , {C}_{B 1} \} , // {L}_{B 1} array 1 ; \\ \{ {Q}_{B 2} , {C}_{B 2} \} , // 2 {L}_{B 1} array 2 ; \\ \{ {Q}_{B 3} , {C}_{B 3} \} , // 3 {L}_{B 1} array 3 ; \\ \{ {Q}_{B 4} , {C}_{B 4} \} , // 4 {L}_{B 1} array 4 ; \\ … wherein {Q}_{B 1} < {Q}_{B 2} < {Q}_{B 3} < {Q}_{B 4} , and {C}_{B 1} < {C}_{B 2} < {C}_{B 3} < {C}_{B 4} .\end{matrix}$$

By taking the fishing line C with the line diameter of 0.3 mm and a nylon wire as an example, the winding data of the fishing line C is as follows:

$$\begin{matrix}\{ {Q}_{C 1} , {C}_{C 1} \} , // {L}_{C 1} array 1 ; \\ \{ {Q}_{B 2} , {C}_{B 2} \} , // 2 {L}_{B 1} array 2 ; \\ \{ {Q}_{B 3} , {C}_{B 3} \} , // 3 {L}_{B 1} array 3 ; \\ \{ {Q}_{B 4} , {C}_{B 4} \} , // 4 {L}_{B 1} array 4 ; \\ … wherein {Q}_{B 1} < {Q}_{B 2} < {Q}_{B 3} < {Q}_{B 4} , and {C}_{B 1} < {C}_{B 2} < {C}_{B 3} < {C}_{B 4} .\end{matrix}$$

In the fishing line A, the fishing line B, and the fishing line C of the above instances, in the case of the same preset length L (namely, L_{A1}=L_{B1}=L_{C1}), the greater the line diameter is, the less the number of circles of winding is and the greater the average perimeter is; the better the wire ductility is, the greater the number of circles of winding is and the less the average perimeter is (the wire ductility: the PE wire<the carbon wire<the nylon wire), namely, Q_{A1}>Q_{B1}>Q_{C1}, and C_{A1}<C_{B1}<C_{C1}; and Q_{A2}>Q_{B2}>Q_{C2}, C_{A2}<C_{B2}<C_{C2}, and it is performed in the same manner . . . . Based on this, for the fishing lines with different line diameter magnitudes and wire types, the corresponding winding database is pre-constructed to provide accurate calculation parameters for the subsequent winding length and unwinding length, so as to improve the calculation accuracy.

It should be noted that the above winding data of a plurality of different fishing lines is subjected to data collection and construction by using the same spool, and if the spools with different inner diameters and diameter lengths are used, the obtained data is different. In the present application, one data instance is provided merely for the convenience of introduction; and it can be adjusted adaptively according to the actual situations.

In one example, step S102 includes:
collecting the current number of circles of winding of the current fishing line on the spool; and calculating the current winding length z of the current number of circles of winding on the spool according to the following formula:

Z=(circle_cnt−line_infos_temp[a][0])*Perimeter+L*a; where circle_cnt represents the current number of circles of winding, line_infos_temp[a][0] represents the total number of circles of winding which is less than and closest to the current number of circles of winding in the arrays, Perimeter represents the average perimeter corresponding to the total number of circles of winding which is greater than and closest to the current number of circles of winding in the arrays, L represents the preset length, and a represents the number of arrays in which the total number of circles of winding is less than the current number of circles of winding.

In this example, when the current number of circles of winding of the current fishing line on the spool is collected, after an end of the current fishing line is fixed on the spool, the winding of the current fishing line is achieved by rotating the spool, and the current number of circles of rotation of the spool is detected by the sensor assembly on the fishing reel, so as to obtain the current number of circles of winding of the current fishing line.

For convenience of understanding the calculation of the current winding length z, by continuing to take the above winding data of the fishing line A, the fishing line B, and the fishing line C as an example, and assuming that one of the fishing lines is selected as the current fishing line for introduction, the details are as follows:
assuming that the fishing line A is selected as the current fishing line, the current number of circles of winding circle_cnt detected by the sensor assembly is I₁ circles, satisfying Q_{A2}<I₁<Q_{A3}, and it can be known from querying the winding data of the fishing line A that the number of circles of winding of the current fishing line exceeds Q_{A2} circles, but does not exceed Q_{A3} circles, so that the current winding length thereof is obtained by winding (I₁−Q_{A2}) circles again on the basis of the Q_{A2} circles, while the length of the Q_{A2} circles is 2L_{A1}, the average perimeter of each circle of the (I₁−Q_{A2}) circles of the fishing line is C_{A3}, and the total length of the (I₁−Q_{A2}) circles of the fishing line is (I₁−Q_{A2})*C_{A3}, namely, the current winding length should be (I₁−Q_{A2})*C_{A3}+2L_{A1}.

A calculation method adopting the formula is as follows: Q_{A2} in array 2 of the fishing line A is selected as line_infos_temp[a][0], C_{A3} in array 3 of the fishing line A is selected as Perimeter, and 2 is taken as a.

Therefore, they are substituted in the calculation formula for the current winding length z: z=(I₁−Q_{A2})*C_{A3}+L_{A1}*2; and a result of the current winding length z may be obtained by calculation.

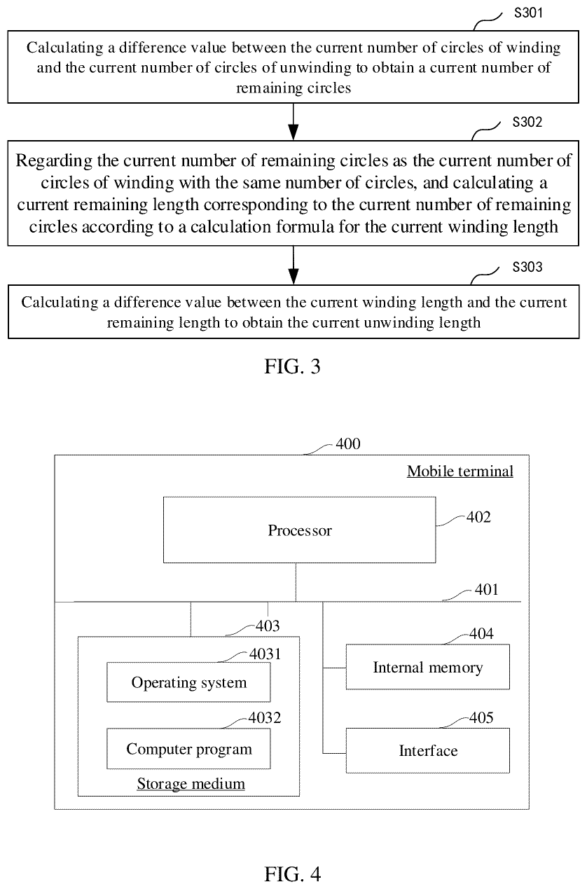

In one example, as shown in FIG. 3, step S104 includes:
S301. calculating a difference value between the current number of circles of winding and the current number of circles of unwinding to obtain a current number of remaining circles;
S302. regarding the current number of remaining circles as the current number of circles of winding with the same number of circles, and calculating a current remaining length corresponding to the current number of remaining circles according to a calculation formula for the current winding length; and
S303. calculating a difference value between the current winding length and the current remaining length to obtain the current unwinding length.

In this example, during casting, the current number of circles of rotation of the spool, which may be taken as the current number of circles of unwinding of the current fishing line, is detected by the sensor assembly, and the current number of remaining circles may be obtained by calculating the difference value between the current number of circles of winding and the current number of circles of unwinding. It may be understood that the results of the calculation of the current remaining length corresponding to the current number of remaining circles and the calculation of the current winding length corresponding to the current number of circles of winding with the same number of circles are the same, for example, the current number of circles of winding and the current number of circles of unwinding are X circles and Y circles, respectively, the current number of remaining circles is X-Y=F circles, the current number of remaining circles of the F circles is regarded as the current number of circles of winding of the F circles, namely, the results of the calculation of the current remaining length corresponding to the current number of remaining circles of the F circles and the calculation of the current winding length corresponding to the current number of circles of winding of the F circles are the same. Therefore, the current number of remaining circles may be regarded as the current number of circles of winding with the same number of circles for calculating the current winding length, and the obtained result is regarded as the current remaining length. Finally, the difference value between the total current winding length and the current remaining length is calculated to obtain the current unwinding length.

For convenience of understanding, by continuing to take the fishing line A being selected as the current fishing line and the current number of circles of winding circle_cnt being I₁ circles which are assumed above as an example, the details are as follows:
assuming that the current number of circles of unwinding being cast is I₂ circles, the current number of remaining circles is I₁−I₂=I₃ circles, after the I₃ circles are regarded as the number of circles of winding, by querying the winding data corresponding to the fishing line A, Q_{A1} in array 1 of the fishing line A is selected as line_infos_temp[a][0], C_{A2} in array 2 of the fishing line A is selected as Perimeter, and 1 is taken as a.

Therefore, they are substituted in the calculation formula for the current winding length z: z=(I₃−Q_{A1})*C_{A2}+L*1; and a result of the current remaining length z may be obtained by calculation. Finally, the difference value between the original total current winding length and the current remaining length z is calculated to obtain the current unwinding length, thereby having the advantage that the calculation of the unwinding length is accurate.

Other contents involved in the method of the present application are further introduced below.

In one example, the fishing data calculation method further includes: detecting a rotation direction of the spool through a sensor assembly on the fishing reel; and identifying an unwinding state and a spooling state of the spool according to the rotation direction of the spool.

In this example, the sensor assembly includes two sets of magneto-resistive sensors (a magneto-resistive sensor A and a magneto-resistive sensor B) and two pieces of magnetite, wherein the two sets of magneto-resistive sensors are disposed on a side cover of the fishing reel, the two sets of magneto-resistive sensors communicate with a Bluetooth chip through a general purpose input/output (GPIO) connector, the two pieces of magnetite are embedded in the spool, one of the two pieces of magnetite facing outwards is an N pole, and the other of the two pieces of magnetite is an S pole. When the magnetite with an N pole face firstly passes through the magneto-resistive sensor A and then passes through the magneto-resistive sensor B, a signal of the magneto-resistive sensor A reaches the Bluetooth chip before a signal of the magneto-resistive sensor B, and the spool is considered to be in the unwinding state, otherwise, the signal of the magneto-resistive sensor A reaches the Bluetooth chip after the signal of the magneto-resistive sensor B, and the spool is considered to be in the spooling state.

In one example, the fishing data calculation method further includes: when the magnetite with the N pole face firstly passes through the magneto-resistive sensor A and the magneto-resistive sensor B, outputting a digital signal 0 to the GPIO connector; when the magnetite with an S pole face then passes through the magneto-resistive sensor A and the magneto-resistive sensor B, outputting a digital signal 1 to the GPIO connector; and when the magnetite with the N pole face then passes through the magneto-resistive sensor A and the magneto-resistive sensor B, outputting the digital signal 0 to the GPIO connector again, namely, when the Bluetooth chip receives a combination of the digital signals 0-1-0, it is considered that the spool rotates by 360°, and thus it is determined that the spool rotates by one circle.

In one example, the fishing data calculation method further includes: detecting the number of circles of rotation of the spool and a rotation time of the spool through the sensor assembly on the fishing reel; obtaining a rotation speed of the spool according to the number of circles of rotation and the rotation time of the spool; and obtaining an unwinding speed and a spooling speed of the spool according to the rotation speed of the spool.

In this example, based on the time t used by the Bluetooth chip to receive the combination of the digital signals 0-1-0, the unwinding speed or the spooling speed m/s is calculated by the formula:

$$\frac{m}{s} = \frac{d}{t} * 10 ;$$

and d is the current average perimeter, in the unit of cm, the unit of t is ms, and *10 represents that the unit of the unwinding speed or the spooling speed is converted into m/s. Thus, the unwinding speed or the spooling speed may be obtained respectively by substituting the unwinding time t and the spooling time t; especially for the calculation of the spooling speed, fake bait in water moves along with the fishing line during spooling, a moving speed of the fake bait is almost the same as the spooling speed, when fish biting occurs during spooling at a certain speed, it is indicated that the current speed is suitable for the current fish species, and the user may control the spooling speed to be within a qualified range after the next casting, so as to improve the fishing efficiency.

In one example, the fishing data calculation method further includes: acquiring the number of circles of rotation of the spool and the rotation time of the spool according to an interrupt signal from the magneto-resistive sensors, so as to obtain the rotation speed of the spool according to the number of circles of rotation of the spool and the rotation time of the spool, and determining whether the rotation speed of the spool is less than a preset secondary unwinding speed threshold x; if so, determining that a sinking distance of bait is a secondary unwinding distance, and recording a previous unwinding distance z1 less than the preset secondary unwinding speed threshold x; and finally, subtracting the unwinding distance z1 from the total unwinding length after casting is completed, so as to obtain the secondary unwinding distance. The secondary unwinding distance may be utilized for estimating a depth of the fake bait after falling into the water to reach a water layer with a target fish species, so as to improve the fishing efficiency.

In one example, the fishing data calculation method further includes: presetting an effective distance range and an effective speed for casting; when a casting distance and a casting speed during the casting process are greater than the effective distance range and the effective speed, respectively, considering rod casting to be effective, and recording a qualified rate of the effective rod casting, so as to prompt the possibility of user operation.

In one example, the fishing data calculation method further includes: obtaining the unwinding length z2 and the spooling length after the current casting; and when the spooling length is less than the unwinding length z2 and delay waiting of a preset time (such as 5 s or other time) is reached, calculating the difference value between the unwinding length z2 and the spooling length, and taking the difference value as a line breaking length. During the next casting, a speed within the initial unwinding length z3 is acquired, and when the speed within the unwinding length z3 exceeds a preset speed (10 m/s), it is determined that line breaking occurs and a prompt is given.

Specifically, an instance is given to explain the line breaking determination principle: assuming that the unwinding length z2 after the current casting is I₄, in the unit of m, and the spooling length is assumed to be I₅; after a preset time, it can be determined that I₄−I₅=I₆ is still outside, and I₆ is assumed to be greater than a line breaking warning length during casting, and there are only two cases: I₆ is broken outside or not completely spooled. It is necessary to refer to the data during the next casting, and if I₆ is not completely spooled, the next casting cannot be normally performed (under normal conditions, the casting cannot be continued if the line not spooled exceeds the line breaking warning length during casting outside), and therefore, the next casting cannot be established; furthermore, if I₆ is broken outside, the next casting is established, and after acquiring the speed within the initial unwinding length z3 after the next casting, when the speed within the unwinding length z3 exceeds the preset speed (this preset speed is a condition set to prevent misjudgment caused by deliberately retaining I₆ for casting, since retaining I₆ may also be that a fishing rod is moved by dragging the line, but a speed condition cannot be triggered to the preset speed), it is determined that line breaking occurs and a line breaking length is prompted.

It should also be noted that the line breaking generally occurs when a rod tip of the fishing rod is broken, and after the line breaking occurs, the broken line is at the top of the fishing rod, but the line breaking length in the line breaking prompt is determined to include a line from the fishing reel to the rod tip of the fishing rod, and therefore when inputting the wire attributes to a mobile terminal, a rod length may also be input, and the addition of this rod length may compensate for the length of the fishing line which is calculated additionally in the line breaking prompt.

In one example, the fishing data calculation method further includes: receiving unwinding data and spooling data of the fishing reel during fishing through a mobile terminal and broadcasting the unwinding data and the spooling data by adopting voice.

In this example, during the process of each casting, the fishing reel may synchronously transmit the states generated during the casting process, such as the unwinding length, the secondary unwinding, the unwinding speed, the spooling speed, the number of times of casting, the line breaking prompt, and the line tangling prompt, to the mobile terminal via Bluetooth, and the mobile terminal transfers the data to the angler by means of voice broadcasting, so as to avoid the distraction of the angler caused by frequently viewing the mobile terminal, thereby improving the fishing experience.

Specifically, referring to FIG. 4, FIG. 4 is a schematic block diagram of a mobile terminal provided in an example of the present disclosure.

Referring to FIG. 4, the mobile terminal 400 includes a processor 402, a memory, and an interface 405 which are connected through a system bus 401, wherein the memory may include a storage medium 403 and an internal memory 404.

The storage medium 403 may store an operating system 4031 and a computer program 4032. The computer program 4032, when executed, may cause the processor 402 to execute the above fishing data calculation method.

The processor 402 is configured to provide calculation and control capabilities to support the running of the whole mobile terminal 400.

The internal memory 404 provides an environment for the running of the computer program 4032 in the storage medium 403, and the computer program 4032, when executed by the processor 402, may cause the processor 402 to execute the above fishing data calculation method.

The interface 405 is configured to communicate with other devices. It will be understood by a person skilled in the art that the structure shown in FIG. 4 is merely a block diagram of a partial structure relevant to the solution of the present application and does not constitute limitation on the mobile terminal 400 to which the solution of the present application is applied, and the specific mobile terminal 400 may include more or fewer components than those shown in the drawings, or combine some components, or have a different arrangement of the components.

The winding database of different fishing lines wound to the spool of the fishing reel is constructed by the mobile terminal 400, and the unwinding length of the fishing line on the spool is calculated by the algorithm based on the fishing line selected by the user when the user performs fishing, so as to improve the calculation accuracy of the unwinding length, so that the angler can well master a casting distance, thereby greatly avoiding ineffective casting and waiting, and effectively improving the use experience.

An example of the present disclosure further provides a fishing reel system, including: a fishing reel and the mobile terminal 400; wherein the fishing reel includes: a fishing reel main body, a spool, a swing arm, and a sensor assembly; the spool is rotatably mounted on the fishing reel main body; the swing arm is rotatably mounted on the fishing reel main body and connected to the spool, and the swing arm is configured to link the spool for forward and reverse rotation, so as to achieve winding and unwinding; and the sensor assembly is disposed between the fishing reel main body and the spool and configured to detect rotation data of the spool.

It will be clearly known to a person skilled in the art that for convenience and brevity of the description, reference may be made to the corresponding processes in the previously described method examples for the specific working processes of the mobile terminal and the fishing reel system described above, which will not be described in detail herein.

The above description is only specific embodiments of the present disclosure, but the scope of protection of the present disclosure is not limited to this. Any person skilled in the art will readily think of various equivalent modifications or substitutions within the technical scope disclosed by the present disclosure, and these modifications or substitutions all should be covered by the scope of protection of the present disclosure. Therefore, the scope of protection of the present disclosure should be determined by the scope of protection of the claims.

1. A fishing data calculation method, comprising:
pre-constructing a winding database of different fishing lines wound to a spool of a fishing reel;
acquiring a current winding length of a current fishing line on the spool;
acquiring a current number of circles of unwinding of the spool during casting; and
calculating a current unwinding length corresponding to the current number of circles of unwinding according to the winding database and the current winding length.

2. The fishing data calculation method according to claim 1, wherein the different fishing lines comprise fishing lines of different wire attributes, and the wire attributes comprise one or more of a line diameter magnitude, a wire type, a wire size, and a wire tensile force.

3. The fishing data calculation method according to claim 1, wherein the pre-constructing a winding database of different fishing lines wound to a spool of a fishing reel, comprises:
when each fishing line is wound to the spool of the fishing reel, collecting the number of circles of winding of the fishing line having each preset length in the spool, and calculating an average perimeter of the fishing line at each preset length;
constructing the total number of circles of winding reaching the preset length each time and the average perimeter of the fishing line corresponding to each preset length into an array, and constructing a plurality of corresponding arrays into winding data corresponding to the fishing line; and
aggregating the winding data of all the different fishing lines and constructing the winding data into a winding database.

4. The fishing data calculation method according to claim 3, wherein the acquiring a current winding length of a current fishing line on the spool, comprises:
acquiring a current number of circles of winding, and calculating the current winding length of the current fishing line on the spool based on the winding database and the current number of circles of winding.

5. The fishing data calculation method according to claim 4, wherein the acquiring a current number of circles of winding, and calculating the current winding length of the current fishing line on the spool based on the winding database and the current number of circles of winding, comprises:
collecting the current number of circles of winding of the current fishing line on the spool; and
calculating the current winding length z of the current number of circles of winding on the spool according to the following formula:
$$z = ( circle\_cnt - line\_infos \_temp [ a ] [ 0 ] ) * Perimeter + L * a ;$$
where circle_cnt represents the current number of circles of winding, line_infos_temp[a][0] represents the total number of circles of winding which is less than and closest to the current number of circles of winding in the arrays, Perimeter represents the average perimeter corresponding to the total number of circles of winding which is greater than and closest to the current number of circles of winding in the arrays, L represents the preset length, and a represents the number of arrays in which the total number of circles of winding is less than the current number of circles of winding.

6. The fishing data calculation method according to claim 5, wherein the calculating a current unwinding length corresponding to the current number of circles of unwinding according to the winding database and the current winding length, comprises:
calculating a difference value between the current number of circles of winding and the current number of circles of unwinding to obtain a current number of remaining circles;
regarding the current number of remaining circles as the current number of circles of winding with the same number of circles, and calculating a current remaining length corresponding to the current number of remaining circles according to a calculation formula for the current winding length; and
calculating a difference value between the current winding length and the current remaining length to obtain the current unwinding length.

7. The fishing data calculation method according to claim 1, further comprising:
detecting a rotation direction of the spool through a sensor assembly on the fishing reel; and
identifying an unwinding state and a spooling state of the spool according to the rotation direction of the spool.

8. The fishing data calculation method according to claim 1, further comprising:
detecting the number of circles of rotation of the spool and a rotation time of the spool through the sensor assembly on the fishing reel;
obtaining a rotation speed of the spool according to the number of circles of rotation and the rotation time of the spool; and
obtaining an unwinding speed and a spooling speed of the spool according to the rotation speed of the spool.

9. The fishing data calculation method according to claim 1, further comprising:
receiving unwinding data and spooling data of the fishing reel during fishing through a mobile terminal and broadcasting the unwinding data and the spooling data by adopting voice.

10. A mobile terminal, comprising a memory and a processor, wherein a computer program is stored in the memory, and the processor, when executing the computer program, implements the fishing data calculation method according to claim 1.

11. A mobile terminal, comprising a memory and a processor, wherein a computer program is stored in the memory, and the processor, when executing the computer program, implements the fishing data calculation method according to claim 2.

12. A mobile terminal, comprising a memory and a processor, wherein a computer program is stored in the memory, and the processor, when executing the computer program, implements the fishing data calculation method according to claim 3.

13. A mobile terminal, comprising a memory and a processor, wherein a computer program is stored in the memory, and the processor, when executing the computer program, implements the fishing data calculation method according to claim 4.

14. A mobile terminal, comprising a memory and a processor, wherein a computer program is stored in the memory, and the processor, when executing the computer program, implements the fishing data calculation method according to claim 5.

15. A mobile terminal, comprising a memory and a processor, wherein a computer program is stored in the memory, and the processor, when executing the computer program, implements the fishing data calculation method according to claim 6.

16. A mobile terminal, comprising a memory and a processor, wherein a computer program is stored in the memory, and the processor, when executing the computer program, implements the fishing data calculation method according to claim 7.

17. A mobile terminal, comprising a memory and a processor, wherein a computer program is stored in the memory, and the processor, when executing the computer program, implements the fishing data calculation method according to claim 8.

18. A mobile terminal, comprising a memory and a processor, wherein a computer program is stored in the memory, and the processor, when executing the computer program, implements the fishing data calculation method according to claim 9.

19. A fishing reel system, comprising a fishing reel and the mobile terminal according to claim 10;
the fishing reel comprising:
a fishing reel main body;
a spool rotatably mounted on the fishing reel main body;
a swing arm rotatably mounted on the fishing reel main body and connected to the spool; and
a sensor assembly disposed between the fishing reel main body and the spool and configured to detect rotation data of the spool.

20. A fishing reel system, comprising a fishing reel and the mobile terminal according to claim 11;
the fishing reel comprising:
a fishing reel main body;
a spool rotatably mounted on the fishing reel main body;
a swing arm rotatably mounted on the fishing reel main body and connected to the spool; and
a sensor assembly disposed between the fishing reel main body and the spool and configured to detect rotation data of the spool.
